(19) United States
(12) Patent Application Publication
(10) Pub. No.: US 2017/0139044 A1
(43) Pub. Date: May 18, 2017

(54) Transducer Elements at Different Tilt Angles

(71) Applicant: Navico Holding AS, Egersund (NO)

(72) Inventor: Matthew Laster, Broken Arrow, OK (US)

(21) Appl. No.: 14/945,288

(22) Filed: Nov. 18, 2015

(51) Int. Cl. G01S 15/89

(52) U.S. Cl. CPC G01S 15/8902

(57) ABSTRACT

Various implementations described herein are directed to technologies for a sonar system for use with a vessel. The sonar system includes a sonar module configured to generate a transmit signal and receive sonar data. The sonar system also includes a transducer array in communication with the sonar module. The transducer array includes a plurality of left transducer elements configured to provide sonar data to the sonar module. Each of the left transducer elements may be configured at a different tilt angle.

### BACKGROUND

The following descriptions and examples do not constitute an admission as prior art by virtue of their inclusion within this section.

Sonar has been used to detect waterborne or underwater objects. For example, sonar devices may be used to determine depth and bottom topography, detect fish or other waterborne contacts, or locate wreckage. Devices such as transducer elements, or transducers, have been developed to produce sound at a particular frequency. These transducer elements may transmit the sound into and through the water, and they may also detect echo returns from sound that return to the transducer elements after reflecting off of an object.

Transducer elements may convert an electrical signal into sound energy and, conversely, may convert sound energy, detected via pressure changes, into an electrical signal. In operation, a transducer element may produce a sound pressure signal which emanates in a beam pattern such that a pressure wave is generated, where the pressure wave expands as it moves away from the source. Reflected sound may then return to the transducer element in the form of a sonar return signal, where the sonar return signal may be interpreted as a surface of an object. Such transducer elements may be directed in various directions from surface or submersible vessels to locate other vessels, or the transducer elements may be directed towards the seabed for navigation and/or target location. In one example, transducer elements may be constructed using piezoelectric material.

To identify objects within water, a sonar system may use one or more transducer elements, where a transmitting element may be used to transmit electrical signals to the transducer elements in order to produce sound energy into and through the water. In one scenario, the sonar system may use a plurality of transmitting elements in order to transmit electrical signals of varying frequencies to the transducer elements.

### SUMMARY

Described herein are implementations of various technologies for a sonar system for use with a vessel. The sonar system includes a sonar module configured to generate a transmit signal and receive sonar data. The sonar system also includes a transducer array in communication with the sonar module. The transducer array includes a plurality of left transducer elements configured to provide sonar data to the sonar module. Each of the left transducer elements may be configured at a different tilt angle.

The sonar system includes a marine electronics device configured to selectively receive sonar data from the plurality of left transducer elements. The marine electronics device further includes a switch configured to select which left transducer element provides sonar data to the sonar module. In one implementation, the switch is a software switch. The switch allows for toggling between an outward side scan beam and a downward side scan beam.

In one implementation, the toggling may be accomplished by receiving all sonar data and excluding certain sonar data from the received sonar data. In another implementation, the toggling may be accomplished by turning one or more of the receiving elements and/or left transducer elements on/off.

The transducer array may further include a plurality of right transducer elements configured to provide sonar data to the sonar module. Each of the right transducer elements may be configured at a different tilt angle.

The plurality of left transducer elements may be seated in the same housing as the plurality of right transducer elements.

Also described herein are implementations of various technologies for a non-transitory computer-readable medium having stored thereon a plurality of computer-executable instructions which, when executed by a computer, cause the computer to: generate a transmit signal; receive sonar data from a plurality of left transducer elements in a side scan transducer, each of the left transducer elements being configured at a different tilt angle; and selectively switch between sonar data from the plurality of left transducer elements in response to an indication received from a marine electronics device.

In one implementation, selectively switching between sonar data includes toggling between an outward side scan beam and a downward side scan beam. The toggling may be accomplished by receiving all sonar data and excluding certain sonar data from the received sonar data. The toggling may also accomplished by turning one or more receiving elements of the sonar module and/or one or more of the left transducer elements on/off.

Further described herein are implementations of various technologies for a sonar system for use with a vessel. The sonar system includes a sonar module configured to generate a transmit signal and receive sonar data. The sonar system also includes an array in communication with the sonar module. The transducer array includes a plurality of right transducer elements configured to provide sonar data to the sonar module. Each of the right transducer elements may be configured at a different tilt angle.

The sonar system includes a marine electronics device configured to selectively receive sonar data from the plurality of right transducer elements. The marine electronics device further includes a switch configured to select which right transducer element provides sonar data to the sonar module. In one implementation, the switch is a software switch. The switch allows for toggling between an outward side scan beam and a downward side scan beam.

In one implementation, the toggling is accomplished by receiving all sonar data and excluding certain sonar data from the received sonar data. In another implementation, the toggling is accomplished by turning one or more of the receiving elements and/or left transducer elements on/off.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates a vessel having a sonar system in accordance with implementations of various techniques described herein.

FIG. 2 illustrates a block diagram of a sonar system in accordance with implementations of various techniques described herein.

FIG. 3 illustrates a cross-sectional view of a transducer array disposed in a housing mounted to a vessel in accordance with implementations of various techniques described herein.

FIG. 4 illustrates a block diagram of a sonar system 400 in accordance with implementations of various techniques described herein.

FIG. 5 illustrates an example schematic of a marine electronics device 500 in accordance with implementations of various techniques described herein.

### DETAILED DESCRIPTION

The following paragraphs provide a brief summary of various technologies and techniques directed at a sonar system described herein.

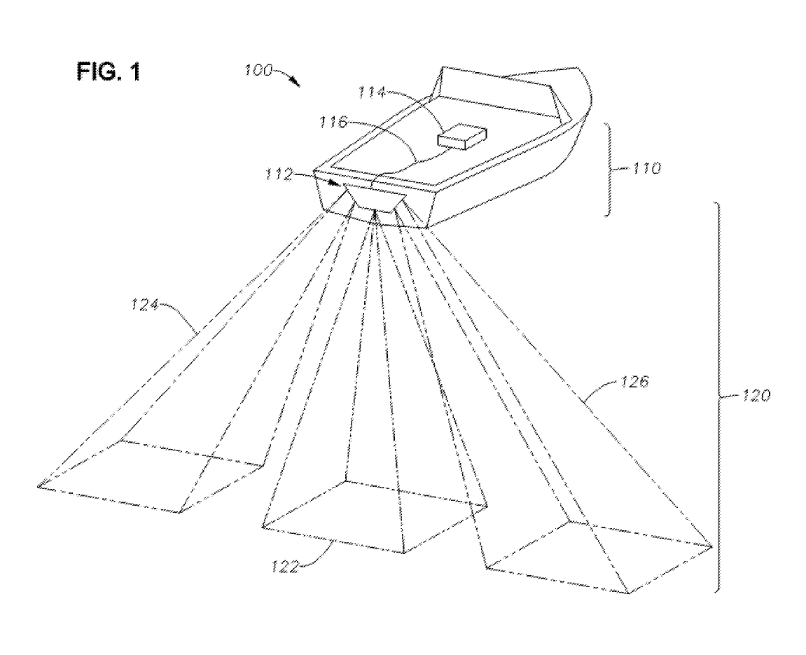

Various implementations of a sonar system described above will now be described in more detail with reference to FIGS. 1-5.

FIG. 1 illustrates a vessel 100 having a sonar system 110 in connection with implementations of various techniques described herein. The sonar system 110 may be coupled or mounted to the vessel 100 and may be configured to identify objects in water to either side of and/or below the vessel 100. The vessel 100 may be a surface water vehicle, a submersible water vehicle, or any other implementation known to those skilled in the art.

The sonar system 110 may include a transducer array 112 coupled to a sonar module 114. In one implementation, the transducer array 112 may be coupled to the sonar module 114 via a communication cable 116. The sonar module 114 may be configured to process data received from the transducer array 112 through the communication cable 116. The transducer array 112 may include a plurality of transducer elements configured to produce one or more sonar beams 120 which provide substantially continuous sonar coverage from one side of the vessel 100 to an opposite side of the vessel 100. As illustrated in FIG. 1, sonar beams 120 may include sonar beam 122, sonar beam 124, and sonar beam 126. The transducer array 112 may include linear and/or circular transducer elements.

In operation, the transducer array 112 may receive one or more transmit signals from the sonar module 114, and, in response, produce one or more sound pressure signals which emanate as one or more sonar beams 120. In one implementation, the transmit signal may be an electrical signal used by the transducer array 112 to produce the sonar beams 120. Reflected sound may then return to the transducer array 112 in the form of one or more sonar return signals, where the sonar return signals may include details about an area of water proximate to the sides and/or the bottom of the vessel 100. In turn, the transducer array 112 may convert the sonar return signals into sonar data to be sent to the sonar module 114, where the sonar data may be one or more electrical signals which may be representative of the sonar return signals.

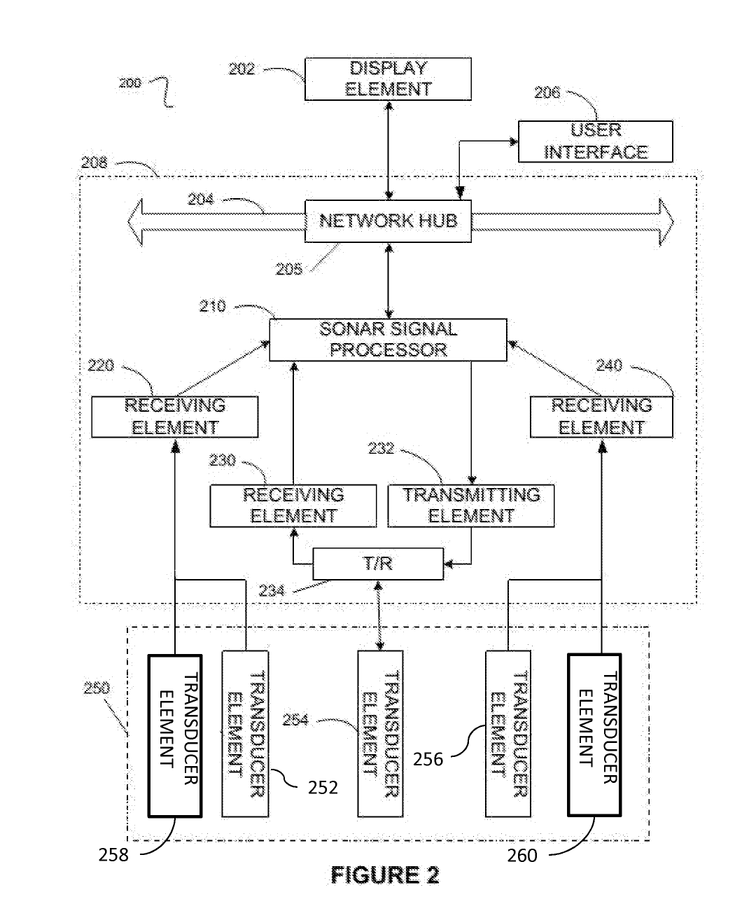

FIG. 2 illustrates a block diagram of a sonar system 200 in accordance with implementations of various techniques described herein. The sonar system 200 may include various components, which may include means embodied in hardware and/or software configured to perform one or more corresponding functions. For example, in one implementation, components of the sonar system 200 may include a display element 202, a user interface 206, a sonar module 208, and a transducer array 250. The sonar system 200 may be similar to the sonar system 110, the sonar module 208 may be similar to the sonar module 114, and the transducer array 250 may be similar to the transducer array 112. Further, the sonar module 208 may include a network hub 205 and a sonar signal processor 210.

The display element 202, the user interface 206, and/or the sonar module 208 may be configured to communicate with one another via a network 204 and/or the network hub 205. The network 204 may include Ethernet or any other network implementation known to those skilled in the art. In one implementation, the display element 202, the user interface 206, and/or the sonar module 208 may be configured to communicate with one another directly without the use of the network 204. The display element 202, the sonar module 208, and/or the user interface 206 may be located in one or more housings. The network hub 205 may include one or more interface ports to allow components, such as the display element 202 or the user interface 206, to communicate with the network 204. In one implementation, the network hub 205 may be configured to allow for plug-and-play communication with the display element 202 and/or the user interface 206.

The display element 202 may be configured to display images, where it may receive data from the sonar signal processor 210 and render the data into one or more windows on the display element 202. For example, the display element 202 may include a liquid crystal display (LCD) screen, a touch screen display, or any other implementation known to those skilled in the art. In one implementation, the display element 202 may include two or more displays.

A user may interact with the sonar system 200 through the user interface 206. The user interface 206 may include, for example, a keyboard, keypad, function keys, mouse, scrolling device, input/output ports, touch screen, or any other user interface known to those skilled in the art. In one implementation, the user interface 206 may be integrated into the display element 202.

The sonar module 208, the display element 202, and/or the user interface 206 may be placed or mounted in the vessel. In one implementation, the sonar module 208 may be a mobile device configured to be placed throughout the vessel. The sonar module 208 may be communicably coupled to the transducer array 250, where the sonar signal processor 210 may be configured to process data received from the transducer array 250. In one implementation, the transducer array 250 may be coupled to the sonar module 208 via a communication cable (not pictured).

The sonar signal processor 210 may be any device or circuitry operating in accordance with hardware and/or software which configures the device or circuitry to perform the corresponding functions of the sonar signal processor 210 as described herein. In some implementations, the sonar signal processor 210 may include a processor, a processing element, a coprocessor, a controller, an application specific integrated circuit (ASIC), a field programmable gate array (FPGA), a hardware accelerator, or any other implementation known to those skilled in the art, where the sonar signal processor 210 is configured to execute various programmed operations or instructions stored in a memory device. The sonar signal processor 210 may further include multiple compatible additional hardware and/or software items configured to: (i) implement signal processing or enhancement features to improve display characteristics, data, and/or images, (ii) collect or process additional data, such as time, temperature, global positioning system (GPS) information, and/or waypoint designations, or (iii) filter extraneous data to better analyze the collected data. The sonar signal processor 210 may further implement notices and alarms, such as those determined or adjusted by a user, to reflect depth, presence of fish, and/or proximity of other watercraft. Still further, the sonar signal processor 210, in combination with suitable memory, may store incoming data from the transducer array 250, screen images for future playback, transfer and/or alter images with additional processing to implement zoom or lateral movement, or correlate data such as fish or bottom features to a GPS position or temperature.

The sonar module 208 may also include a left receiving element 220, a down receiving element 230, a transmitting element 232, a transmit/receive (T/R) switch 234, and a right receiving element 240. The left receiving element 220, the down receiving element 230, the transmitting element 232, the T/R switch 234, and the right receiving element 240 may each be any device or circuitry operating in accordance with hardware and/or software which configures the device or circuitry to perform their respective functions as described herein.

The transmitting element 232 may be configured to send a transmit signal from the sonar signal processor 232 to the transducer array 250. The transmitting element 232 may be a transmitter, a transceiver, or any other implementation known to those skilled in the art. In addition, the left receiving element 220, the down receiving element 230, and the right receiving element 240 may each be configured to receive respective sonar data from the transducer array 250. The left receiving element 220, the down receiving element 230, and the right receiving element 240 may each be a receiver, a transceiver, or any other implementation known to those skilled in the art. In one implementation, the left receiving element 220, the down receiving element 230, and the right receiving element 240 may each be configured to filter its received sonar data based on a specified frequency.

In addition, the left receiving element 220, the down receiving element 230, and the right receiving element 240 may each be configured to send their respective filtered sonar data to the sonar signal processor 210. In one implementation, the filtered sonar data may be displayed using the display element 202 after being received from the sonar signal processor 210. In another implementation, the T/R switch 234 may be used to alternate between sending the transmit signal to the transducer array 250 or sending respective sonar data to the down receiving element 230.

The transducer array 250 may be disposed in one or more housings that are positioned on, or placed proximate to, the vessel employing the sonar system 200. In one implementation, the transducer array 250 may be disposed in one or more housings that are flexibly mounted to a hull of the vessel. In another implementation, the transducer array 250 may be mounted onto another device or component attached to the hull, such as a trolling motor or other steerable device. In yet another implementation, the transducer array 250 and the sonar module 208 may be placed in the same housing.

The transducer array 250 may include a plurality of transducer elements, including a first left transducer element 252, a second left transducer element 258, a down transducer element 254, a first right transducer element 256, and a second right transducer element 260, some of which may be disposed within the one or more housings. The transducer elements may be substantially identical in terms of construction and/or geometrical dimensions, while also differing in terms of orientation and/or usage. For example, the first left transducer element 252, the second left transducer element 258, the down transducer element 254, the first right transducer element 256, and the second right transducer element 260 may each be a linear transducer element, such that each may be substantially rectangular in shape. In addition, the transducer elements may each be constructed using piezoelectric material. In one implementation, the transducer elements may be employed in a sidescan sonar configuration to identify objects in water below and to either side of the vessel. In other implementations, the transducer elements may include any combination of one or more circular transducer elements, one or more linear transducer elements, or any other transducer element known to those skilled in the art.

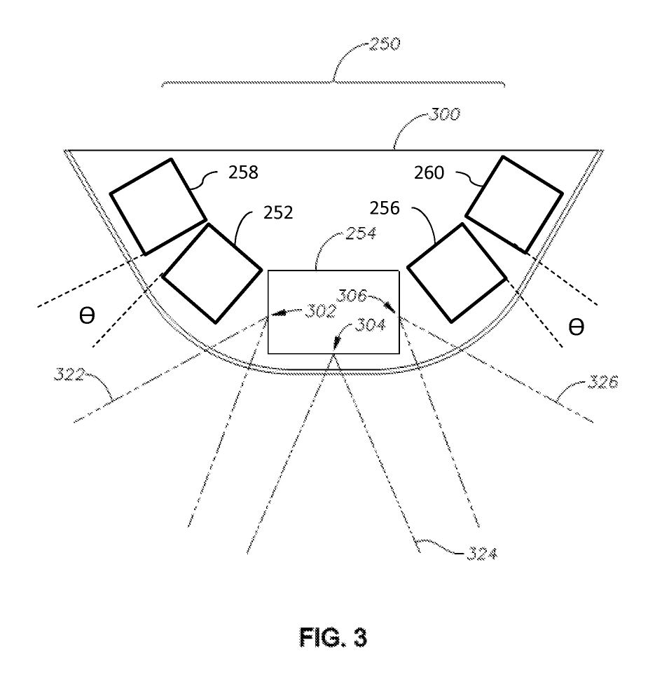

One implementation of the transducer array 250 including the first left transducer element 252, the second left transducer element 258, the down transducer element 254, the first right transducer element 256, and the second right transducer element 260 is described in more detail with respect to FIG. 3. FIG. 3 illustrates a cross-sectional view of the transducer array 250 disposed in a housing 300 mounted to the vessel in accordance with implementations of various techniques described herein. Although FIG. 3 only illustrates two pairs (left and right, e.g., 252, 256 and 258, 260) of receiving elements, where each pair is configured at a particular angle (⊖), e.g., a tilt angle, the solution described herein also applies to configurations having more than two pairs of receiving elements. In one implementation, the number of receiving elements that can be included may be limited by the size of the housing 300.

In operation, the down transducer element 254 may receive the transmit signal from the transmitting element 232, and, in response, produce one or more sonar beams through areas of water proximate to the sides of and/or below the vessel. For example, a left face 302 of the down transducer element 254 may produce a sonar beam 322 directed to an area of water proximate to and/or below a left side of the vessel. A down face 304 of the down transducer element 254 may also produce a sonar beam 324 directed to a water column substantially below the vessel. Further, a right face 306 of the down transducer element 254 may produce a sonar beam 326 directed to an area of water proximate to and/or below a right side of the vessel. In addition, the first left transducer element 252, the second left transducer element 258, the first right transducer element 256 and the second right transducer element 260 may be configured to produce sonar beams in some implementations and may not produce sonar beams in other implementations.

The down transducer element 254 may insonify areas of water proximate to the sides of and/or below the vessel, whereby the sonar beams 322, 324, and 326 provide substantially continuous sonar coverage from one side of the vessel to an opposite side of the vessel. In one implementation, an acoustic shield may be applied to the down transducer element 254 such that the down transducer element 254 may produce the sonar beams 322, 324, and 326 in desired directions in the areas of water proximate to the sides of and/or below the vessel.

The first left transducer element 252, the second left transducer element 258, the down transducer element 254, the first right transducer element 256, and the right transducer element 260 may each be configured to receive respective sonar return signals from respective areas of water proximate to and/or below the vessel. For example, the first left transducer element 252 may be positioned on a left side of the housing 300 to receive sonar return signals from the area of water proximate to and/or below the left side of the vessel. The second left transducer element 258 may be placed at a different angle (⊖) relative to the first left transducer element 252 and positioned on the left side of the housing 300 to receive sonar return signals from the area of water proximate to and/or below the left side of the vessel. The first right transducer element 256 may be positioned on a right side of the housing 300 to receive sonar return signals from the area of water proximate to and/or below the right side of the vessel. The second right transducer element 260 may be placed at a different angle (⊖) relative to the first right transducer element 256 and positioned on the right side of the housing 300 to receive sonar return signals from the area of water proximate to and/or below the right side of the vessel. The down transducer element 254 may be positioned substantially between the left transducer elements 252, 258 and the right transducer elements 256, 260 in the housing 300 to receive sonar return signals from the water column substantially below the vessel. In one implementation, an acoustic shield may be applied to the transducer elements such that the transducer elements receive respective sonar return signals from respective desired areas of water.

The left transducer elements 252, 258, the down transducer element 254, and the right transducer elements 256, 260 may each be configured to also send respective sonar data to the sonar module 208, where the respective sonar data may be representative of respective sonar return signals. For example, the left transducer elements 252, 258 may selectively provide left sonar data to be sent to the left receiving element 220. The down transducer element 254 may provide down sonar data to be sent to the down receiving element 230. The right transducer elements 256, 260 may selectively provide right sonar data to be sent to the right receiving element 240. As mentioned previously, the left receiving element 220, the down receiving element 230, and the right receiving element 240 may each filter its received sonar data based on a respective specified frequency and send its filtered sonar data to the sonar signal processor 210. The filtered sonar data may then be displayed using the display element 202.

When using a large coverage area structure scan, the amount of distance that a user is able to look out versus down is related to the angle at which the element in the transducer is mounted. Conventional techniques typically utilize one element to the left and one element to the right using a side scanning operation.

Various techniques described herein provide a way to adjust the side scanning data to either search further out to see data from a further distance or search more down to obtain a higher resolution picture. This is accomplished by providing a plurality of side scanning transducer elements at different angles. Conventional techniques only provide one transducer element on each side that is mounted at a certain angle by the manufacturer. Previous attempts have been made to increase the scanning distance in a sonar system. Those previous attempts to determine ways to increase the scanning distance in side scan transducers include providing a left transducer and a right transducer in separate elements. Each of the separate elements is manually adjustable. A major drawback is that tools are required for an angler to manually adjust a tilt angle of separate elements in order to change a scan area. In some cases, this manual adjustment must be made to a transducer element that is mounted under a boat.

Various techniques described herein provide a transducer with two different sets of elements set at different degree tilts. The different degree tilts can be user selected using software in a multi-functional display. The two elements in each set are arranged at different tilt angles, so one points more downward and the other points more outward. A user has the ability to change between a far distance setting and a more downward looking setting as it relates to side scanning sonar.

Present day side scanning devices only include one transducer element on each side. By including a second element on each side that is mounted at a different angle, a user can switch between the two transducer elements to change between the transducer element that looks further out and one that looks further down. By having multiple side scanning elements mounted at different angles, a user is able to switch between transducer elements on each side on the fly.

Having side scanning elements mounted at different angles is beneficial to anglers in transition areas. Anglers will now have the ability to change between a side scan beam, designed for more distance, or one that has better detail below the vessel.

The first left and right transducer elements may be seated in a metal chassis and may be epoxied in place so that they cannot be moved. A second transducer element can be included on each side either on top of an adjacent transducer element or below. In one implementation, the second transducer elements are placed at a different angle. A user can select which element to use and change on the fly between the view that looks in a more downward direction and the one that looks in a more outward direction.

The down scan and side scan (left and right) module may be in the same transducer. The down scan module and side scan module may also be embodied in separate transducers. The forward scan module may be disposed in a separate module. Multiple transducers may be installed on one boat to obtain all necessary views.

In one implementation, one transducer may perform the left scanning, right scanning, and down scanning. As such, this one transducer may include left elements, right elements, and a down element.

In another implementation, two left elements and two right elements may be disposed in the same transducer, and the user has the ability to select views that look further out or further down by selecting a pair of elements (left and right) set at a particular angle. In addition, the user has the ability to toggle by switching between the different views. View selection can be accomplished by using a multi-functional display (MFD) device.

As shown in FIG. 2, receiving elements in the sonar module may receive sonar data from multiple transducer elements. In one implementation, each transducer element is coupled to a corresponding receiving element in the sonar module. In another implementation, toggling may be accomplished by receiving all sonar data and excluding certain sonar data from the received sonar data. In yet another implementation, toggling may be accomplished by turning certain elements on/off. For example, one or more transducer elements and/or a receiving elements may be switched on/off in order to include/exclude certain sonar data.

A software switch may be used to allow a user to change between different elements in the same transducer. A transducer (traditional or scanning) can be fitted with multiple elements that search in different directions. The user can be given the ability to change between which element they wanted to view at any given time, thereby changing the size or direction of the search area.

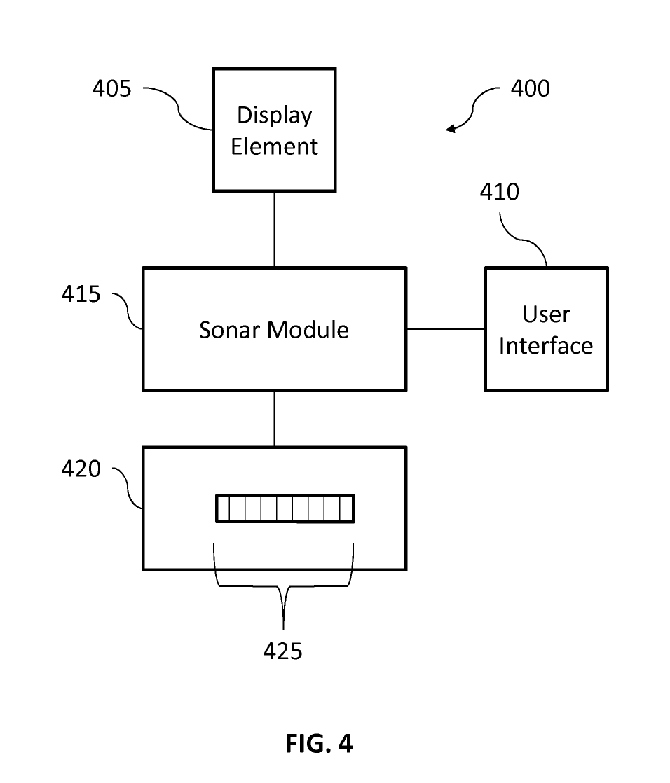

FIG. 4 illustrates a block diagram of a sonar system 400 in accordance with implementations of various techniques described herein. The sonar system 400 may include various components, which may include means embodied in hardware and/or software configured to perform one or more corresponding functions. For example, in one implementation, components of the sonar system 400 may include a display element 405, a user interface 410, a sonar module 415, and a transducer array 420 that includes multi-element transducer array 425. The sonar system 400 may be similar to the sonar system 110, 200 and the sonar module 415 may be similar to the sonar module 114, 208. Further, the sonar module 415 may, like sonar module 208, include a network hub and a sonar signal processor. The display element 405 and the user interface 410 may be similar to the display element 202 and user interface 410 may be similar to the user interface 206. In one implementation, the number of receiving elements in the sonar module 415 correspond to the amount of transducer elements in the multi-element transducer array 425.

Conventional techniques provide no way to select different elements in a multi-element transducer. An example of a multi-element transducer is a compressed high intensity radar pulse (CHIRP) transducer. In some implementations, CHIRP transducers are compatible with a broadband sounder module.

In regular 2D sonar (regular standard sonar picture), the resultant picture is usually created using a transducer that has one circular downward looking element. Larger transducers or beam steering transducers usually include multiple elements. For example, some larger transducers can have at least 37 elements. In one implementation, the elements within the multi-element transducers are not pointed at different angles. A search area can be changed just by choosing which elements to turn on and off, e.g., enabling only a subset of the elements in the multi-element transducer array. Therefore, the size, e.g., beam width, and/or direction of a search area can be changed by turning on and off certain elements in the multi-element transducer array. In one implementation, software running in a device, e.g., a marine electronics device or some other device, allows multi-element transducers (arranged at the same angle or at different angles) to be switched between the multiple elements. The software switch can be used to select which of the elements in the multi-element array should be enabled.

In one implementation, data from the multi-element transducers is collected, however, the software switch is used to receive sonar data from a subset of the elements. In another implementation, the software switch may selectively switch on/off one or more elements in order to include/exclude sonar data.

In one implementation, a transducer has four elements configured in a circle. In this implementation, an image can be produced in any direction. This can occur by providing the option to select different elements.

In another implementation, four circular elements can be arranged in a diamond shape. In another implementation, thirty six small elements can be arranged in a parallelogram and used as one big transducer. All of the elements are laid flat in the transducer. In addition, all of the current multi-element transducer solutions have elements that are placed at the same angle.

Various techniques described herein include at least one additional transducer element placed at a different angle from a first element for a particular view, e.g., left side and/or right side, of a side scanning transducer. While the sonar system described herein is directed to a side scanning sonar system, it should be understood that the concepts and techniques described herein are also applicable to sonar systems exhibiting different element configurations. Thus, the techniques described herein may be applied to forward scanning, rearward scanning, and/or down scanning configurations/devices, and other types of sonar systems, e.g., CHIRP or traditional sonar, that can be used to acquire sonar data.

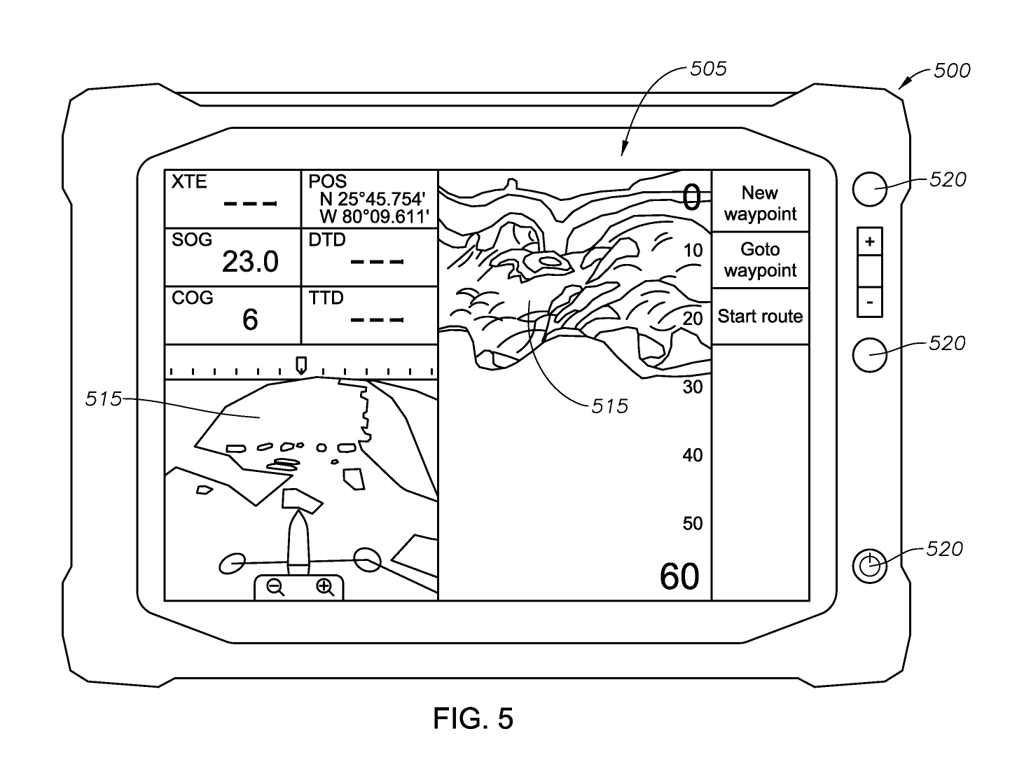

In one implementation, the computing device is a marine electronics device, e.g., a MFD. In this implementation, the user interface 206, 410 may be integrated into the display element 202, 405. FIG. 5 illustrates an example schematic of a marine electronics device 500 in accordance with implementations of various techniques described herein. The marine electronics device 500 includes a screen 505. In certain implementations, the screen 505 may be sensitive to touching by a finger. In other implementations, the screen 505 may be sensitive to the body heat from the finger, a stylus, or responsive to a mouse. The marine electronics device 500 may be attached to a National Marine Electronics Association (NMEA) bus or network. The marine electronics device 500 may send or receive data to or from another device attached to the NMEA 2000 bus. For example, the marine electronics device 500 may transmit commands and receive data from a motor or a sensor using an NMEA 2000 bus. In one implementation, the marine electronics device 500 may be capable of steering a vessel and controlling the speed of the vessel, i.e., autopilot. For example, one or more waypoints may be input to the marine electronics device 500, and the marine electronics device 500 may steer a vessel to the one or more waypoints. The marine electronics device 500 may transmit or receive NMEA 2000 compliant messages, messages in a proprietary format that do not interfere with NMEA 2000 compliant messages or devices, or messages in any other format. In various implementations, the marine electronics device 500 may be attached to various other communication buses and/or networks configured to use various other types of protocols that may be accessed via, e.g., NMEA 2000, NMEA 0183, Ethernet, Proprietary wired protocol, etc. In some implementations, the marine electronics device 500 may communicate with other devices on the vessel via wireless communication protocols.

In one implementation, the marine electronics device 500 may communicate with the sonar module 114, 208, 415 to selectively view sonar data from a subset of receiving elements. When the marine electronics device 500 is used in conjunction with a side scanner, the sonar data may be selectively received from a subset of the receiving elements. In order to provide scanning of multiple search areas, at least two pairs (left element and right element) of receiving elements is provided. Each pair of receiving elements is configured at a particular angle. When the marine electronics device is used in conjunction with a multi-element array, the sonar data may be selectively received from one or more of the elements in the multi-element array.

The marine electronics device 500 may be operational with numerous general purpose or special purpose computing system environments or configurations. The marine electronics device 500 may include any type of electrical and/or electronics device capable of processing data and information via a computing system. The marine electronics device 500 may include a marine instrument, such that the marine electronics device 500 may use the computing system to display and/or process the one or more types of marine electronics data. The marine electronics device 500 may be configured to display marine electronic data 515, such as, e.g., chart data, radar data, sonar data, steering data, dashboard data, navigation data, fishing data, engine data, lighting operation data, and the like. Further, the marine electronics device 500 may also include one or more buttons 520 that may include either physical buttons or virtual buttons, or a combination thereof. Still further, the marine electronics device 500 may receive input through a screen 505 sensitive to touch or buttons 520.

The computing system may include a central processing unit (CPU), a system memory, a graphics processing unit (GPU), and a system bus that couples various system components including the system memory to the CPU. The computing system may include one or more CPUs, which may include a microprocessor, a microcontroller, a processor, a programmable integrated circuit, or a combination thereof. The CPU may include an off-the-shelf processor such as a Reduced Instruction Set Computer (RISC), or a Microprocessor without Interlocked Pipeline Stages (MIPS) processor, or a combination thereof. The CPU may also include a proprietary processor.

The GPU may be a microprocessor specifically designed to manipulate and implement computer graphics. The CPU may offload work to the GPU. The GPU may have its own graphics memory, and/or may have access to a portion of the system memory. As with the CPU, the GPU may include one or more processing units, and each processing unit may include one or more cores.

The CPU may provide output data to a GPU. The GPU may generate graphical user interfaces that present the output data. The GPU may also provide objects, such as menus, in the graphical user interface. A user may provide inputs by interacting with the objects. The GPU may receive the inputs from interaction with the objects and provide the inputs to the CPU. A video adapter may be provided to convert graphical data into signals for a monitor (MFD 500). The monitor (MFD 500) includes a screen 505. In certain implementations, the screen 505 may be sensitive to touching by a finger. In other implementations, the screen 505 may be sensitive to the body heat from the finger, a stylus, or responsive to a mouse.

The system bus may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory may include a read only memory (ROM) and a random access memory (RAM). A basic input/output system (BIOS), containing the basic routines that help transfer information between elements within the computing system, such as during start-up, may be stored in the ROM.

The computing system may further include a hard disk drive interface for reading from and writing to a hard disk, a memory card reader for reading from and writing to a removable memory card, and an optical disk drive for reading from and writing to a removable optical disk, such as a CD ROM or other optical media. The hard disk, the memory card reader, and the optical disk drive may be connected to the system bus by a hard disk drive interface, a memory card reader interface, and an optical drive interface, respectively. The drives and their associated computer-readable media may provide nonvolatile storage of computer-readable instructions, data structures, program modules and other data for the computing system.

Although the computing system is described herein as having a hard disk, a removable memory card and a removable optical disk, it should be appreciated by those skilled in the art that the computing system may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules, software modules, or other data. Computer-readable storage media may include non-transitory computer-readable storage media. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR), and other wireless media. The computing system may include a host adapter that connects to a storage device via a small computer system interface (SCSI) bus, Fiber Channel bus, eSATA bus, or using any other applicable computer bus interface.

The computing system can also be connected to a router to establish a wide area network (WAN) with one or more remote computers. The router may be connected to the system bus via a network interface. The remote computers can also include hard disks that store application programs. In another implementation, the computing system may also connect to the remote computers via local area network (LAN) or the WAN. When using a LAN networking environment, the computing system may be connected to the LAN through the network interface or adapter. The LAN may be implemented via a wired connection or a wireless connection. The LAN may be implemented using WiFi™ technology, cellular technology, Bluetooth™ technology, satellite technology, or any other implementation known to those skilled in the art. The network interface may also utilize remote access technologies (e.g., Remote Access Service (RAS), Virtual Private Networking (VPN), Secure Socket Layer (SSL), Layer 2 Tunneling (L2T), or any other suitable protocol). In some examples, these remote access technologies may be implemented in connection with the remote computers. It will be appreciated that the network connections shown are exemplary and other means of establishing a communications link between the computer systems may be used.

A number of program modules may be stored on the hard disk, memory card, optical disk, ROM or RAM, including an operating system, one or more application programs, and program data. In certain implementations, the hard disk may store a database system. The database system could include, for example, recorded points. The application programs may include various mobile applications (“apps”) and other applications configured to perform various methods and techniques described herein. The operating system may be any suitable operating system that may control the operation of a networked personal or server computer.

A user may enter commands and information into the computing system through input devices such as buttons, which may be physical buttons, virtual buttons, or combinations thereof. Other input devices may include a microphone, a mouse, or the like (not shown). These and other input devices may be connected to the CPU through a serial port interface coupled to system bus, but may be connected by other interfaces, such as a parallel port, game port or a universal serial bus (USB).

Certain implementations may be configured to be connected to a global positioning system (GPS) receiver system and/or a marine electronics system. The GPS system and/or marine electronics system may be connected via the network interface. The GPS receiver system may be used to determine position data for the vessel on which the marine electronics device 500 is disposed. The GPS receiver system may then transmit the position data to the marine electronics device 500. In other examples, any positioning system known to those skilled in the art may be used to determine and/or provide the position data for the marine electronics device 500.

The marine electronics system may include one or more components disposed at various locations on the vessel. Such components may include one or more data modules, sensors, instrumentation, and/or any other devices known to those skilled in the art that may transmit various types of data to the marine electronics device 500 for processing and/or display. The various types of data transmitted to the marine electronics device 500 from the marine electronics system may include marine electronics data and/or other data types known to those skilled in the art. The marine electronics data received from the marine electronics system may include chart data, sonar data, structure data, radar data, navigation data, position data, heading data, automatic identification system (AIS) data, Doppler data, speed data, course data, or any other type known to those skilled in the art.

In one implementation, the marine electronics system may include a radar sensor for recording the radar data and/or the Doppler data, a compass heading sensor for recording the heading data, and a position sensor for recording the position data. In a further implementation, the marine electronics system may include a sonar transducer for recording the sonar data, an AIS transponder for recording the AIS data, a paddlewheel sensor for recording the speed data, and/or the like.

The marine electronics device 500 may receive external data via the LAN or the WAN. In one implementation, the external data may relate to information not available from the marine electronics system. The external data may be retrieved from the Internet or any other source. The external data may include atmospheric temperature, tidal data, weather, moon phase, sunrise, sunset, water levels, historic fishing data, and other fishing data.

In one implementation, the marine electronics device 500 may be a multi-function display (MFD) unit, such that the marine electronics device 500 may be capable of displaying and/or processing multiple types of marine electronics data. FIG. 5 illustrates a schematic diagram of an MFD unit in accordance with implementations of various techniques described herein. In particular, the MFD unit may include the computing system, the monitor (MFD 500), the screen 505, and the buttons such that they may be integrated into a single console.

The discussion above is directed to certain specific implementations. It is to be understood that the discussion above is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

Reference has been made in detail to various implementations, examples of which are illustrated in the accompanying drawings and figures. In the above detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

As used herein, the terms “up” and “down”; “upper” and “lower”; “upwardly” and downwardly”; “below” and “above”; and other similar terms indicating relative positions above or below a given point or element may be used in connection with some implementations of various technologies described herein. However, when applied to equipment and methods for use in wells that are deviated or horizontal, or when applied to equipment and methods that when arranged in a well are in a deviated or horizontal orientation, such terms may refer to a left to right, right to left, or other relationships as appropriate.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A sonar system for use with a vessel, comprising:
a sonar module configured to generate a transmit signal and receive sonar data; and
a transducer array in communication with the sonar module and comprising a plurality of left transducer elements configured to provide sonar data to the sonar module, each of the left transducer elements being configured at a different tilt angle.

2. The sonar system of claim 1, further comprising a marine electronics device configured to selectively receive sonar data from the plurality of left transducer elements.

3. The sonar system of claim 2, wherein the marine electronics device further comprises a switch configured to select which left transducer element provides sonar data to the sonar module.

4. The sonar system of claim 3, wherein the switch is a software switch.

5. The sonar system of claim 3, wherein the switch allows for toggling between an outward side scan beam and a downward side scan beam.

6. The sonar system of claim 5, wherein the toggling is accomplished by receiving all sonar data and excluding certain sonar data from the received sonar data.

7. The sonar system of claim 5, wherein the toggling is accomplished by turning one or more of the receiving elements and/or left transducer elements on/off.

8. The sonar system of claim 1, wherein the transducer array further comprises a plurality of right transducer elements configured to provide sonar data to the sonar module, each of the right transducer elements being configured at a different tilt angle.

9. The sonar system of claim 8, wherein the plurality of left transducer elements are seated in the same housing as the plurality of right transducer elements.

10. A non-transitory computer-readable medium having stored thereon a plurality of computer-executable instructions which, when executed by a computer, cause the computer to:
generate a transmit signal;
receive sonar data from a plurality of left transducer elements in a side scan transducer, each of the left transducer elements being configured at a different tilt angle; and
selectively switch between sonar data from the plurality of left transducer elements in response to an indication received from a marine electronics device.

11. The non-transitory computer readable medium of claim 10, wherein selectively switching between sonar data comprises toggling between an outward side scan beam and a downward side scan beam.

12. The non-transitory computer readable medium of claim 11, wherein the toggling is accomplished by receiving all sonar data and excluding certain sonar data from the received sonar data.

13. The sonar system of claim 11, wherein the toggling is accomplished by turning one or more receiving elements of the sonar module and/or one or more of the left transducer elements on/off.

14. A sonar system for use with a vessel, comprising:
a sonar module configured to generate a transmit signal and receive sonar data; and
a transducer array in communication with the sonar module and comprising a plurality of right transducer elements configured to provide sonar data to the sonar module, each of the right transducer elements being configured at a different tilt angle.

15. The sonar system of claim 14, further comprising a marine electronics device configured to selectively receive sonar data from the plurality of right transducer elements.

16. The sonar system of claim 15, wherein the marine electronics device further comprises a switch configured to select which right transducer element provides sonar data to the sonar module.

17. The sonar system of claim 16, wherein the switch is a software switch.

18. The sonar system of claim 16, wherein the switch allows for toggling between an outward side scan beam and a downward side scan beam.

19. The sonar system of claim 18, wherein the toggling is accomplished by receiving all sonar data and excluding certain sonar data from the received sonar data.

20. The sonar system of claim 18, wherein the toggling is accomplished by turning one or more of the receiving elements and/or left transducer elements on/off.
